(19) United States
(12) Patent Application Publication
(10) Pub. No.: US 2016/0132829 A1
(43) Pub. Date: May 12, 2016

(54) PROGRAM AND PROJECT ASSESSMENT SYSTEM

(71) Applicant: BANK OF AMERICA CORPORATION, Charlotte, NC (US)

(72) Inventors: Angela Barbarito Lukin, Seekonk, MA (US); David Nathan Owen, Charlotte, NC (US); Larry E. Cravens, Matthews, NC (US); Peter A. Babb, II, Charlotte, NC (US); Robert J. Maloney, Iron Station, NC (US)

(21) Appl. No.: 14/539,441

(22) Filed: Nov. 12, 2014

(51) Int. Cl. G06Q 10/10

(52) U.S. Cl. CPC G06Q 10/103

(57) ABSTRACT

Disclosed is a program and project assessment system. The program and project assessment system typically includes a processor, a memory, and a program and project assessment module stored in the memory. The program and project assessment system is typically configured for: receiving lagging indicator data regarding a plurality of programs; determining a cumulative program quality control score for each of a plurality of program groups; receiving current indicator data regarding the plurality of programs; determining a cumulative overall status score and a cumulative outcome completion score for each program group; receiving leading indicator data regarding the plurality of programs; determining a plurality of cumulative predictive condition scores for each program group; and providing to a user computing device an assessment interface depicting the cumulative program quality control scores, cumulative overall status scores, the cumulative outcome completion scores, and the cumulative predictive condition scores for the plurality of program groups.

### FIELD OF THE INVENTION

The present invention embraces a program and project assessment system. The system typically includes a processor and a memory. The system also typically includes a program and project assessment module stored in the memory, which is typically configured for receiving lagging indicator data, current indicator data, and lagging indicator data regarding a plurality of programs. Based on this received data, the module determines cumulative program quality control scores, cumulative overall status scores, cumulative outcome completion scores, and cumulative predictive condition scores for a plurality of program groups. These scores are then provided to a user computing device via an assessment interface.

### BACKGROUND

Various methods exist to help businesses assess the status of programs and projects. That said, a need exists for an improved way for quickly assessing the status of programs and projects.

### SUMMARY

In one aspect, the present invention embraces a program and project assessment system and an associated method and computer program product. The program and project assessment system typically includes a processor and a memory. The program and project assessment system also typically includes a program and project assessment module stored in the memory and executable by the processor.

In one embodiment, the program and project assessment module is configured for receiving lagging indicator data regarding a plurality of programs, the lagging indicator data comprising a quality control score for each of the programs. Based on the received lagging indicator data, the program and project assessment module determines a cumulative program quality control score for each of a plurality of program groups, each program group comprising a subset of the plurality of programs. The program and project assessment module also receives current indicator data regarding the plurality of programs, the current indicator data comprising (i) an overall status score for each of the plurality of programs and (ii) outcome completion information for each of the plurality of programs. Based on the received current indicator data, the program and project assessment module determines a cumulative overall status score and a cumulative outcome completion score for each program group. The program and project assessment module also receives leading indicator data regarding the plurality of programs, the leading indicator data comprising a plurality of predictive condition scores for each of the plurality of programs. Based on the received leading indicator data, the program and project assessment module determines a plurality of cumulative predictive condition scores for each program group. The program and project assessment module then provides an assessment interface to a user computing device, the assessment interface depicting the cumulative program quality control scores, the cumulative overall status scores, the cumulative outcome completion scores, and the cumulative predictive condition scores for the plurality of program groups.

In a particular embodiment, based on the received lagging indicator data, the program and project assessment module determines an aggregate program quality control score for the plurality of programs. Based on the received current indicator data, the program and project assessment module also determines an aggregate overall status score and an aggregate outcome completion score for the plurality of programs. In addition, based on the received current indicator data, the program and project assessment module determines a plurality of aggregate predictive condition scores for the plurality of programs.

In another particular embodiment, the lagging indicator data comprise a plurality of project quality control scores, each project quality control score being associated with a project that is associated with one of said plurality of programs. In addition, the program and project assessment aggregation module is configured for, based on the received lagging indicator data, determining a cumulative project quality control score for each of the plurality of program groups. The assessment interface depicts the cumulative project quality control scores.

In yet another particular embodiment, the plurality of predictive condition scores comprises a future outcomes score, a resource score, a schedule score, a budget score, and a client/employee readiness score for each of the plurality of programs. The plurality of cumulative predictive condition scores may include a cumulative future outcomes score, a cumulative resource score, a cumulative schedule score, a cumulative budget score, and a cumulative client/employee readiness score for each program group.

In yet another particular embodiment, receiving leading indicator data regarding the plurality of programs comprises prompting a user to answer one or more questions.

In yet another particular embodiment, the assessment interface comprises a graphical user interface.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIG. 1 depicts a program and project assessment system and operating environment in accordance with an exemplary embodiment of the present invention;

FIG. 2 schematically depicts a program and project assessment system in accordance with an exemplary embodiment of the present invention;

FIG. 3 depicts a method of assessing the status of programs and projects in accordance with an exemplary embodiment of the present invention;

FIG. 4 depicts an exemplary assessment interface in accordance with an exemplary embodiment of the present invention;

FIG. 5A depicts another exemplary assessment interface in accordance with an exemplary embodiment of the present invention; and

FIG. 5B depicts yet another exemplary assessment interface in accordance with an exemplary embodiment of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

In accordance with embodiments of the invention, the terms “financial institution” and “financial entity” include any organization that processes financial transactions including, but not limited to, banks, credit unions, savings and loan associations, investment companies, stock brokerages, asses management firms, insurance companies and the like. In specific embodiments of the invention, use of the term “bank” is limited to a financial entity in which account-bearing customers conduct financial transactions, such as account deposits, withdrawals, transfers and the like.

Although some embodiments of the invention herein are generally described as involving a “financial institution,” one of ordinary skill in the art will appreciate that other embodiments of the invention may involve other businesses that take the place of or work in conjunction with the financial institution to perform one or more of the processes or steps described herein as being performed by a financial institution. Still in other embodiments of the invention the financial institution described herein may be replaced with other types of businesses that engage in risk assessment and management.

A “user” may be any person or entity using a program and project assessment system described herein. Often, a user is an employee of an entity (e.g., a financial institution) using a program and project assessment system. In some instances a user has a management position within an entity using a program and project assessment system.

As used herein, the term “program” relates to a large body of work that has the goal of achieving one or more business outcomes. A program may have a defined beginning and end or may be ongoing. In contrast, the term “project” relates to an endeavor within a program undertaken to provide one or more outputs. These outputs typically help to achieve one or more business goals of an overarching program. While a program is often ongoing, projects typically have a defined beginning and end.

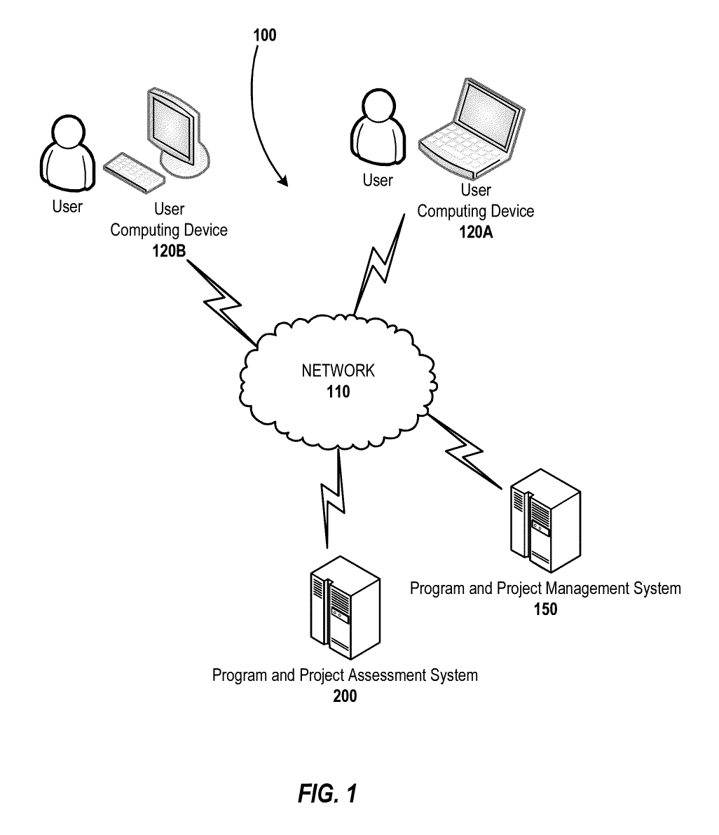

In one aspect, the present invention embraces a program and project assessment system that may be used by an entity, such as a financial institution, to quickly assess the status of entity programs and projects. In this regard, FIG. 1 depicts an operating environment 100 according to one embodiment of the present invention that facilitates program and project assessment for an entity (e.g., a financial institution). The operating environment includes a program and project assessment system 200. In addition, one or more users, each having a user computing device 120, such as a PC, laptop, mobile phone, tablet, television, mobile device, or the like, may be in communication with the program and project assessment system 200 via a network 100, such as the Internet, wide area network, local area network, Bluetooth network, near field network, or any other form of contact or contactless network. The operating environment may also include other entity devices and systems, including a program and project management system 150.

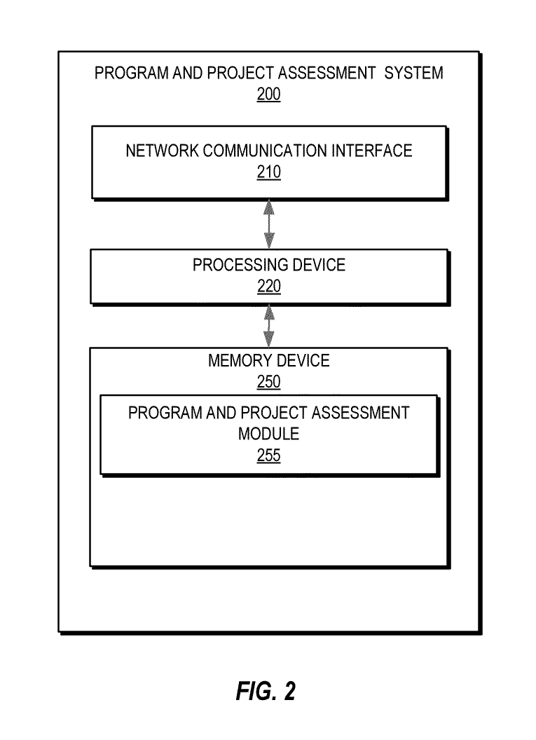

FIG. 2 depicts the program and project assessment system 200 in more detail. As depicted in FIG. 2 the program and project assessment system 200 typically includes various features such as a network communication interface 210, a processing device 220, and a memory device 250. The network communication interface 210 includes a device that allows the program and project assessment system 200 to communicate over the network 110 (shown in FIG. 1) with the user computing devices 120. In this regard, an interface (e.g., a graphical user interface) is typically presented on each user computing device to allow each user to interact with the program and project assessment system 200.

As used herein, a “processing device,” such as the processing device 220, generally refers to a device or combination of devices having circuitry used for implementing the communication and/or logic functions of a particular system. For example, a processing device 220 may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device 220 may further include functionality to operate one or more software programs based on computer-executable program code thereof, which may be stored in a memory. As the phrase is used herein, a processing device 220 may be “configured to” perform a certain function in a variety of ways, including, for example, by having one or more general-purpose circuits perform the function by executing particular computer-executable program code embodied in computer-readable medium, and/or by having one or more application-specific circuits perform the function.

As used herein, a “memory device,” such as the memory device 250, generally refers to a device or combination of devices that store one or more forms of computer-readable media for storing data and/or computer-executable program code/instructions. Computer-readable media is defined in greater detail below. For example, in one embodiment, the memory device 250 includes any computer memory that provides an actual or virtual space to temporarily or permanently store data and/or commands provided to the processing device 220 when it carries out its functions described herein.

As noted, the program and project assessment system 200 is configured to assess the status of programs and projects. Accordingly, the program and project assessment system 200 typically includes one or more modules stored in the memory device 250, which facilitate the assessment of programs and projects. As depicted in FIG. 2, the program and project assessment system 200 typically includes a program and project assessment module 255.

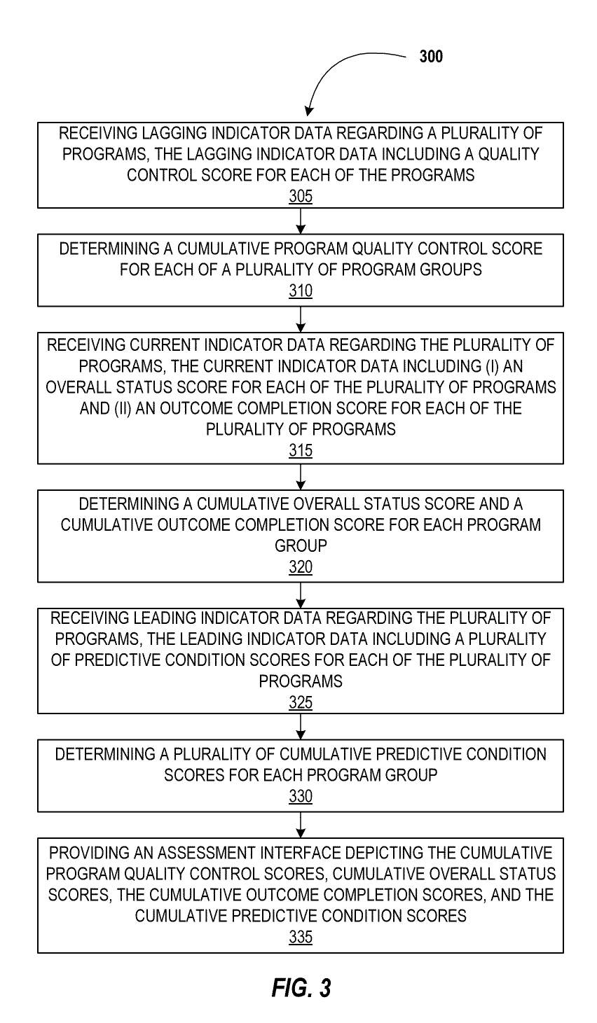

The program and project assessment module 255 is typically configured so that one or more users can interact (e.g., via user computing devices) with the program and project assessment system 200 in order to assess the status of programs and projects. In this regard, FIG. 3 depicts a method 300 of assessing the status of programs and projects that may be performed by the program and project assessment module 255.

Accordingly, at block 305, the program and project assessment module 255 is typically configured to receive (e.g., retrieve) lagging indicator data regarding a plurality of programs. The lagging indicator data may be received from another entity system, such as the program and project management system 150. The plurality of programs may include all active entity programs. Alternatively, the plurality of programs may include a subset of active entity programs. For example, the plurality of programs may include those programs that are defined as high rigor programs. The level of rigor typically relates to the level of scrutiny that is applied to a program to ensure that the program achieves its defined business outcomes and does not negatively impact the entity as a whole. A high rigor program is typically a program determined to have higher associated risks and/or have higher importance to the entity.

Typically, this lagging indicator data include a quality control score for each of the plurality of programs. The quality control score for a program typically reflects the extent to which the planning and execution of the program has followed the entity's rules, guidelines, procedures, and the like. The quality control score for each program may be determined by a program and project management system of the entity. Accordingly, the quality control score for each program may be retrieved from such program and project management system of the entity (e.g., the program and project management system 150 depicted in FIG. 1). Exemplary program and project management systems are disclosed in commonly assigned U.S. patent application Ser. No. 13/955,900 for a Quality Assurance and Control Tool (filed Jul. 31, 2013); U.S. patent application Ser. No. 13/956,042 for a Program and Project Risk Tool (filed Jul. 31, 2013); and U.S. patent application Ser. No. 14/456,781 for Risk-Based Execution for Projects (filed Aug. 11, 2014), each of which is hereby incorporated by reference in its entirety. Alternatively, the quality control score for each program may be retrieved from other entity systems or databases.

This lagging indicator data may also include a quality control score for the projects associated with each of the plurality of programs. In this regard, each program may include one or more projects. As noted above, each project is typically an endeavor within a program undertaken to provide one or more outputs to achieve one or more business goals of such program. The quality control score for a project typically reflects the extent to which the planning and execution of the project has followed the entity's rules, guidelines, procedures, and the like. The quality control score for each project may be determined by and received from a program and project management system of the entity.

Based on the received lagging indicator data, at block 310, the program and project assessment module 255 typically determines a cumulative program quality control score for each of a plurality of program groups. Each program group typically includes a subset of the plurality of programs. Typically, each program group includes all programs associated with a particular line of business, department, organization, or the like within the entity. That said, a program group may include programs having any common characteristic. For example, a program group may include all programs overseen by the same manager, executive, or the like. A Program group may also include all programs (i) having the same status or program phase, (ii) having common metrics, (iii) impacting a particular location or region, (iv) all programs impacting a particular entity asset, system, or process, or (v) any other common characteristic. A user may select the program group(s) being assessed by the program and project assessment module 255. For example, a user may select all programs with the programs being grouped by line of business, or the user may select a single program group in which all programs impact the same geographic region.

The cumulative program quality control score for each program group is typically calculated by taking the average of the quality control scores for the programs associated with the program group. If lagging indicator data is unavailable for a particular program, the cumulative program quality control score may indicate that data is unavailable. The program and project assessment module 255 may also similarly determine an aggregate program quality control score for the plurality of programs (e.g., by calculating the average of the quality control scores for all of the plurality of programs).

If quality control scores for the projects associated with the plurality of programs have been received, then a cumulative project quality control score for each of the plurality of program groups may be similarly determined (e.g., by calculating the average of the quality control scores of the projects for the programs associated with each program group). If lagging indicator data is unavailable for a particular program, the cumulative project quality control score may indicate that data is unavailable. The program and project assessment module 255 may also determine an aggregate project quality control score for the plurality of programs (e.g., by calculating the average of the quality control scores for all of the projects of the plurality of programs).

At block 315, the program and project assessment module 255 is typically configured to receive (e.g., retrieve) current indicator data regarding a plurality of programs. The current indicator data may be received from another entity system, such as the program and project management system 150. The current indicator data typically include an overall status score for each of the plurality of programs. The overall status score for each program reflects the current status of each program. Typically, the overall status score of a program reflects the status of the program as provided by a program manager or other qualified user. Accordingly, the program and project assessment module 255 may retrieve the overall status score for each program from a qualified user (e.g., program manager) associated with each program. In some embodiments, the program and project assessment module 255 may prompt qualified users associated with the programs (e.g., via a graphical user interface (GUI) presented to the user) to provide the overall status scores for the programs (e.g., by prompting qualified users to answer one or more questions). For example, each qualified user may provide an overall status score of green (i.e., the program is in good shape), yellow (i.e., there is reason for caution), or red (i.e., the program has problems) for each program.

The current indicator data also typically include outcome completion information for each of the plurality of programs. The outcome completion information for a program typically reflects the extent to which recently expected outcomes (e.g., goals) for the program have been successfully completed. More typically, the outcome completion information for a program reflects the extent to which outcomes expected to be completed during a recent time period (e.g., the preceding month) were successfully completed. In this regard, users may employ the entity's program and project management system 150 to define for each program one or more outcomes. The users may also define for each outcome metrics by which success can be measured as well as a completion schedule. Subsequently, users may update the program and project management system 150 regarding the status of the programs. Accordingly, the outcome completion information for each program may be retrieved from the program and project management system 150 of the entity. Alternatively, the program and project assessment module 255 may retrieve outcome completion information (e.g., outcome metrics, status, and completion schedule) from the program and project management system and then use this information to determine the outcome completion information for each program.

Based on the received current indicator data, at block 320, the program and project assessment module 255 typically determines a cumulative overall status score and a cumulative outcome completion score for each program group. The cumulative overall status score for each program group is typically calculated by determining the percentage of programs within each program group having a green overall status score. The percentage of programs within each program group having other overall status scores (e.g., yellow or red) may also be determined. The cumulative outcome completion score for each program group is typically calculated by determining the percentage of programs within each program group successfully completing their outcomes scheduled for completion during a recent time period. If current indicator data is unavailable for a particular program, the cumulative overall status score and cumulative outcome completion score may indicate that data is unavailable. The program and project assessment module 255 may also determine an aggregate overall status score for the plurality of programs (e.g., by determining the percentage of the plurality of programs having a green overall status score) and an aggregate outcome completion score for the plurality of programs (e.g., by determining the percentage of the plurality of programs having successfully completed all scheduled outcomes during a recent time period). Although typically calculated by the program and project assessment module 255, other entity systems may calculate cumulative overall status scores and/or an aggregate outcome completion score.

At block 325, the program and project assessment module 255 is typically configured to receive (e.g., retrieve) leading indicator data regarding a plurality of programs. The leading indicator data typically include a plurality of predictive condition scores for each of the plurality of programs. Exemplary predictive condition scores include: a future outcomes score, which may reflect the extent to which a qualified user (e.g., program manager) believes a program will be able to achieve its future outcomes; a resource score, which may reflect the extent to which a qualified user believes a program will have sufficient resources to be successful; a schedule score, which may reflect the extent to which a qualified user believes a program will be able to stay on schedule; a budget score, which may reflect the extent to which the program is on budget; and a client/employee readiness score, which may reflect the extent to which a qualified user believes that clients and employees are ready for future implementations of the program. Accordingly, the program and project assessment module 255 may retrieve such predictive condition scores for each program from a qualified user (e.g., program manager) associated with each program. In some embodiments, the program and project assessment module 255 may prompt qualified users associated with the programs (e.g., via a graphical user interface (GUI) presented to the user) to provide such predictive condition scores for the programs (e.g., by prompting qualified users to answer one or more questions). Each qualified user may provide predictive condition scores of green (i.e., the program is in good shape), yellow (i.e., there is reason for caution), or red (i.e., the program has problems) for each program. In some embodiments, the budget score for each program may be determined by the program and project assessment module 255 by retrieving budget information from the entity's program and project management system and using such information to calculate the budget score.

Based on the received leading indicator data, at block 330, the program and project assessment module 255 typically determines cumulative predictive condition scores for each program group (e.g., a cumulative future outcomes score, a cumulative resource score, a cumulative schedule score, a cumulative budget score, and a cumulative client/employee readiness score for each program group.). The cumulative predictive condition scores for each program group is typically calculated by determining the percentage of programs within each program group having a green score for each type of predictive condition score. The percentage of programs within each program group having other scores (e.g., yellow or red) for each type of predictive condition score may also be determined. If leading indicator data is unavailable for a particular program, the cumulative predictive condition scores may indicate that data is unavailable. The program and project assessment module 255 may also determine aggregate predictive condition scores for the plurality of programs (e.g., by determining the percentage of the plurality of programs having a green overall status score for each type of predictive condition score). The percentage of programs having other predictive condition scores (e.g., yellow or red) may also be determined.

Although FIG. 3 depicts the steps of blocks 305-310, 315-320, and 325-330 as occurring in a particular order, it is within the scope of the present invention for these steps to occur in any order or currently.

At block 335, the program and project assessment module 255 is typically configured to provide an assessment interface depicting any of the above determined scores. The assessment interface is typically a graphical user interface (GUI) that is provided (e.g., via the network 110) to a user computer device (e.g., any of the user computing devices 120 depicted in FIG. 1). Typically, the assessment interface includes the cumulative program quality control scores, cumulative overall status scores, cumulative outcome completion scores, and cumulative predictive condition scores. The assessment interface may also include cumulative project quality control scores, aggregate program and/or project quality control scores, aggregate overall status scores, an aggregate outcome completion score, and/or aggregate predictive condition scores. The assessment interface may include one or more colors associated with the depicted scores. Certain colors, such as green or white, may be associated with relatively high or otherwise desirable scores. Other colors, such as red, yellow, or blue, may be associated with lower or otherwise less desirable scores. A color associated with a particular score may be depicted via the interface as overlaying or approximate to the particular score (e.g., by using colored text, backgrounds, or borders).

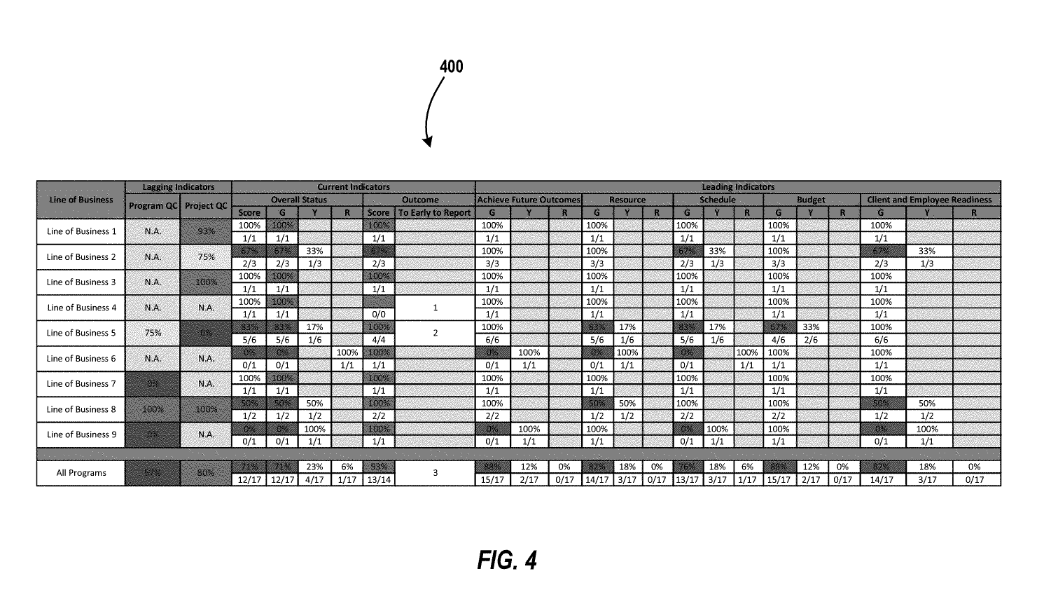

FIG. 4 depicts an exemplary assessment interface 400 in accordance with the present invention. The leftmost column of the exemplary assessment interface includes different entity lines of business. The next two columns include cumulative program and project quality control scores for the programs within each line of business. The next column depicts a cumulative overall status score, both as a percentage and fraction of programs having a green overall status score, for the programs within each line of business. The next three columns respectively depict the number of programs within each line of business having a green, yellow, or red overall status score. The next column depicts a cumulative outcome completion score, both as a percentage and fraction of expected outcomes completed during the previous month, for the programs within each line of business. The next column depicts the number of programs for which data is not yet available. The remaining columns depict cumulative predictive condition scores, namely future outcomes scores, resource scores, schedule scores, budget scores, and client/employee readiness scores, for the programs within each line of business. The bottom row of the exemplary assessment interface includes aggregate scores for all the programs.

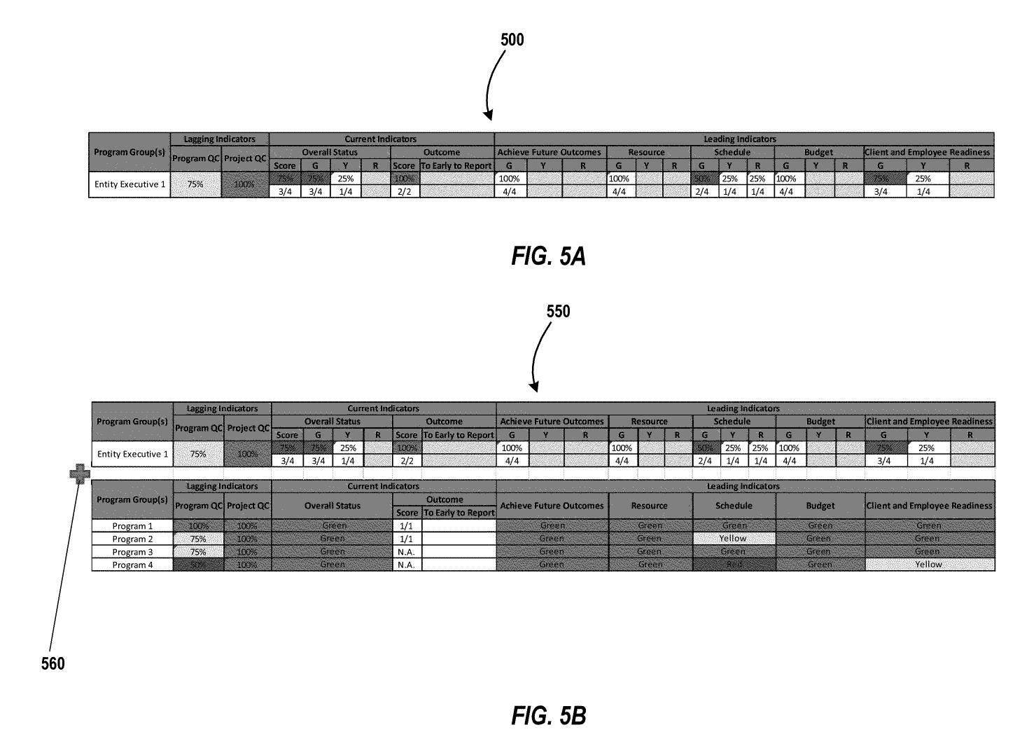

As noted above, users may be able to select the program group(s) being assessed by the program and project assessment module 255 (and thus depicted in a graphical user interface). In this regard, FIG. 5A depicts another exemplary assessment interface 500 in accordance with the present invention in which a user has selected a single program group containing all programs associated with a particular entity executive.

In some embodiments, users may be able to select one or more program groups depicted in an assessment interface in order to view information (e.g., lagging indicator data, current indicator data, and lagging indicator data) regarding each program associated with the program groups. In this regard, FIG. 5B depicts an exemplary assessment interface 550 in which a user has used a button 560 to view the individual programs (and related information) associated with the program group depicted in FIG. 5B.

As will be appreciated by one of skill in the art, the present invention may be embodied as a method (including, for example, a computer-implemented process, a business process, and/or any other process), apparatus (including, for example, a system, machine, device, computer program product, and/or the like), or a combination of the foregoing. Accordingly, embodiments of the present invention may take the form of an entirely hardware embodiment, an entirely software embodiment (including firmware, resident software, micro-code, and the like), or an embodiment combining software and hardware aspects that may generally be referred to herein as a “system.” Furthermore, embodiments of the present invention may take the form of a computer program product on a computer-readable medium having computer-executable program code embodied in the medium.

Any suitable transitory or non-transitory computer readable medium may be utilized. The computer readable medium may be, for example but not limited to, an electronic, magnetic, optical, electromagnetic, infrared, or semiconductor system, apparatus, or device. More specific examples of the computer readable medium include, but are not limited to, the following: an electrical connection having one or more wires; a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

In the context of this document, a computer readable medium may be any medium that can contain, store, communicate, or transport the program for use by or in connection with the instruction execution system, apparatus, or device. The computer usable program code may be transmitted using any appropriate medium, including but not limited to the Internet, wireline, optical fiber cable, radio frequency (RF) signals, or other mediums.

Computer-executable program code for carrying out operations of embodiments of the present invention may be written in an object oriented, scripted or unscripted programming language. However, the computer program code for carrying out operations of embodiments of the present invention may also be written in conventional procedural programming languages, such as the “C” programming language or similar programming languages.

Embodiments of the present invention are described above with reference to flowchart illustrations and/or block diagrams of methods, apparatus (systems), and computer program products. It will be understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks.

These computer-executable program code portions may also be stored in a computer-readable memory that can direct a computer or other programmable data processing apparatus to function in a particular manner, such that the code portions stored in the computer readable memory produce an article of manufacture including instruction mechanisms which implement the function/act specified in the flowchart and/or block diagram block(s).

The computer-executable program code may also be loaded onto a computer or other programmable data processing apparatus to cause a series of operational steps to be performed on the computer or other programmable apparatus to produce a computer-implemented process such that the code portions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

Embodiments of the present invention are described above with reference to flowcharts and/or block diagrams. It will be understood that steps of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

1. A program and project assessment system, comprising:
a processor;
a memory;
a program and project assessment module stored in the memory, executable by the processor and configured for:
receiving lagging indicator data regarding a plurality of programs, the lagging indicator data comprising a quality control score for each of the programs;
based on the received lagging indicator data, determining a cumulative program quality control score for each of a plurality of program groups, each program group comprising a subset of the plurality of programs;
receiving current indicator data regarding the plurality of programs, the current indicator data comprising (i) an overall status score for each of the plurality of programs and (ii) outcome completion information for each of the plurality of programs;
based on the received current indicator data, determining a cumulative overall status score and a cumulative outcome completion score for each program group;
receiving leading indicator data regarding the plurality of programs, the leading indicator data comprising a plurality of predictive condition scores for each of the plurality of programs;
based on the received leading indicator data, determining a plurality of cumulative predictive condition scores for each program group; and
providing an assessment interface to a user computing device, the assessment interface depicting the cumulative program quality control scores, the cumulative overall status scores, the cumulative outcome completion scores, and the cumulative predictive condition scores for the plurality of program groups.

2. The program and project assessment system according to claim 1, wherein the program and project assessment module is configured for:
based on the received lagging indicator data, determining an aggregate program quality control score for the plurality of programs;
based on the received current indicator data, determining an aggregate overall status score and an aggregate outcome completion score for the plurality of programs; and
based on the received current indicator data, determining a plurality of aggregate predictive condition scores for the plurality of programs.

3. The program and project assessment system according to claim 1, wherein:
the lagging indicator data comprise a plurality of project quality control scores, each project quality control score being associated with a project that is associated with one of said plurality of programs;
the program and project assessment aggregation module is configured for, based on the received lagging indicator data, determining a cumulative project quality control score for each of the plurality of program groups; and
the assessment interface depicts the cumulative project quality control scores.

4. The program and project assessment system according to claim 1, wherein:
the plurality of predictive condition scores comprises a future outcomes score, a resource score, a schedule score, a budget score, and a client/employee readiness score for each of the plurality of programs; and
the plurality of cumulative predictive condition scores comprises a cumulative future outcomes score, a cumulative resource score, a cumulative schedule score, a cumulative budget score, and a cumulative client/employee readiness score for each program group.

5. The program and project assessment system according to claim 1, wherein receiving leading indicator data regarding the plurality of programs comprises prompting a user to answer one or more questions.

6. The program and project assessment system according to claim 1, wherein the assessment interface comprises a graphical user interface.

7. A computer program product for providing program and project assessment comprising a non-transitory computer-readable storage medium having computer-executable instructions for:
receiving lagging indicator data regarding a plurality of programs, the lagging indicator data comprising a quality control score for each of the programs;
based on the received lagging indicator data, determining a cumulative program quality control score for each of a plurality of program groups, each program group comprising a subset of the plurality of programs;
receiving current indicator data regarding the plurality of programs, the current indicator data comprising (i) an overall status score for each of the plurality of programs and (ii) outcome completion information for each of the plurality of programs;
based on the received current indicator data, determining a cumulative overall status score and a cumulative outcome completion score for each program group;
receiving leading indicator data regarding the plurality of programs, the leading indicator data comprising a plurality of predictive condition scores for each of the plurality of programs;
based on the received leading indicator data, determining a plurality of cumulative predictive condition scores for each program group; and
providing an assessment interface to a user computing device, the assessment interface depicting the cumulative program quality control scores, the cumulative overall status scores, the cumulative outcome completion scores, and the cumulative predictive condition scores for the plurality of program groups.

8. The computer program product according to claim 7, wherein the non-transitory computer-readable storage medium has computer-executable instructions for:
based on the received lagging indicator data, determining an aggregate program quality control score for the plurality of programs;
based on the received current indicator data, determining an aggregate overall status score and an aggregate outcome completion score for the plurality of programs; and
based on the received current indicator data, determining a plurality of aggregate predictive condition scores for the plurality of programs.

9. The computer program product according to claim 7, wherein:
the lagging indicator data comprise a plurality of project quality control scores, each project quality control score being associated with a project that is associated with one of said plurality of programs;
the non-transitory computer-readable storage medium has computer-executable instructions for, based on the received lagging indicator data, determining a cumulative project quality control score for each of the plurality of program groups; and
the assessment interface depicts the cumulative project quality control scores.

10. The computer program product according to claim 7, wherein:
the plurality of predictive condition scores comprises a future outcomes score, a resource score, a schedule score, a budget score, and a client/employee readiness score for each of the plurality of programs; and
the plurality of cumulative predictive condition scores comprises a cumulative future outcomes score, a cumulative resource score, a cumulative schedule score, a cumulative budget score, and a cumulative client/employee readiness score for each program group.

11. The computer program product according to claim 7, wherein receiving leading indicator data regarding the plurality of programs comprises prompting a user to answer one or more questions.

12. The computer program product according to claim 7, wherein the assessment interface comprises a graphical user interface.

13. A method for providing program and project assessment, comprising:
receiving, via a computer processor, lagging indicator data regarding a plurality of programs, the lagging indicator data comprising a quality control score for each of the programs;
based on the received lagging indicator data, determining, via a computer processor, a cumulative program quality control score for each of a plurality of program groups, each program group comprising a subset of the plurality of programs;
receiving, via a computer processor, current indicator data regarding the plurality of programs, the current indicator data comprising (i) an overall status score for each of the plurality of programs and (ii) outcome completion information for each of the plurality of programs;
based on the received current indicator data, determining, via a computer processor, a cumulative overall status score and a cumulative outcome completion score for each program group;
receiving, via a computer processor, leading indicator data regarding the plurality of programs, the leading indicator data comprising a plurality of predictive condition scores for each of the plurality of programs;
based on the received leading indicator data, determining, via a computer processor, a plurality of cumulative predictive condition scores for each program group; and
providing, via a computer processor, an assessment interface to a user computing device, the assessment interface depicting the cumulative program quality control scores, the cumulative overall status scores, the cumulative outcome completion scores, and the cumulative predictive condition scores for the plurality of program groups.

14. The method according to claim 13, comprising:
based on the received lagging indicator data, determining an aggregate program quality control score for the plurality of programs;
based on the received current indicator data, determining an aggregate overall status score and an aggregate outcome completion score for the plurality of programs; and
based on the received current indicator data, determining a plurality of aggregate predictive condition scores for the plurality of programs.

15. The method according to claim 13, wherein:
the lagging indicator data comprise a plurality of project quality control scores, each project quality control score being associated with a project that is associated with one of said plurality of programs;
the method comprises, based on the received lagging indicator data, determining a cumulative project quality control score for each of the plurality of program groups; and
the assessment interface depicts the cumulative project quality control scores.

16. The method according to claim 13, wherein:
the plurality of predictive condition scores comprises a future outcomes score, a resource score, a schedule score, a budget score, and a client/employee readiness score for each of the plurality of programs; and
the plurality of cumulative predictive condition scores comprises a cumulative future outcomes score, a cumulative resource score, a cumulative schedule score, a cumulative budget score, and a cumulative client/employee readiness score for each program group.

17. The method according to claim 13, wherein receiving leading indicator data regarding the plurality of programs comprises prompting a user to answer one or more questions.

18. The method according to claim 13, wherein the assessment interface comprises a graphical user interface.
